(19) United States
(12) Patent Application Publication
(10) Pub. No.: US 2008/0168754 A1
(43) Pub. Date: Jul. 17, 2008

(54) Exhaust Gas Particulate Filter

(75) Inventors: Marcus Frey, Waiblingen (DE); Carsten Kohberg, Menden (DE); Dominik Lamotte, Unna (DE); Uwe Schumacher, Soest (DE)

Correspondence Address: PATENT LAW OFFICES OF RICK MARTIN, PC, PO BOX 1839, LONGMONT, CO, 80502, US

(73) Assignees: DAIMLER CHRYSLER AG, Stuttgart (DE); PUREM ABGASSYSTEME GMBH &CO KG, Unna (DE)

(21) Appl. No.: 11/569,748

(22) PCT Filed: Jun. 1, 2005
(86) PCT No.: PCT/EP2005/005869

§ 371 Date: Nov. 27, 2007

(30) Foreign Application Priority Data
Jun. 2, 2004 (DE) 10 2004 026 798.7

(51) Int. Cl. B01D 29/56

(52) U.S. Cl. 55/488

(57) ABSTRACT

The invention relates to an exhaust particulate filter with a filter body (4), comprising a number of filter pockets (3) arranged one behind the other and formed by filter plates (1), the filter plates (1) having a planar cutout opening (2).

According to the invention, it is provided that the peripheral contour (8) of the planar cutout opening (2) comprises points which are located at different distances from the centroid (S) of the area of the cutout opening (2).

For an exhaust particulate filter according to the invention, it is further provided that the centroid (S) of its at least one area of the cutout opening (2) is arranged at a distance from the central longitudinal axis (7) of the filter body (4) on the filter plate (1) or that the filter body (4) has filter plates (1) with different cutout openings (2).

The exhaust particulate filter is suitable in particular for an application in motor vehicles with a diesel engine.

### CROSS REFERENCE APPLICATIONS

This application is a national stage application of PCT application No. PCT/EP2005/005869 filed on Jun. 1, 2005 and claiming priority from German application 10 2004 026 798.7 filed on Jun. 2, 2004.

### BACKGROUND

The invention relates to an exhaust particulate filter comprising a number of filter pockets arranged one behind the other and formed by filter plates.

The utility model DE 200 04 162 U1 discloses an exhaust particulate filter which is formed by a filter body inserted in a filter housing. The filter body is made from individual filter pockets arranged one behind the other in the main direction of exhaust flow. The filter pockets are formed from two directly neighboring sintered metal filter plates being attached to one another. Such filter bodies are used for filtering out soot particulates from the exhaust of diesel engines. The sintered metal filter plates have a central, circular cutout opening, which functions to carry the filtered exhaust gas away.

In the case of corresponding filter bodies, uncleaned exhaust gas flows in a substantially radial direction with respect to the cylindrical filter body through the sintered metal filter plates into the inner region of the filter body. Particulates are filtered out from the exhaust gas and deposit themselves on the outside of the sintered metal filter plates forming the filter pocket walls when they pass through the sintered metal filter plates. The cleaned exhaust gas flows out in an axial direction with respect to the filter body at one end of the filter body and is preferably received by an exhaust pipe.

In these exhaust particulate filters, dead zones in terms of flow often form in the region of the cutout openings of the filter pockets, both on the outer raw exhaust gas side and in the cleaned gas region inside the filter body or the filter pocket. These zones are barely reached by the exhaust gas flow because deflections and backflows at these locations lead to a locally increased flow resistance, causing a correspondingly higher exhaust counter pressure. This reduces the efficiency of such a filter system, which must be compensated for by a greater overall volume.

The foregoing example of the related art and limitations related therewith are intended to be illustrative and not exclusive. Other limitations of the related art will become apparent to those of skill in the art upon a reading of the specification and a study of the drawings.

### SUMMARY

An aspect of the invention is to provide an exhaust particulate filter with improved filtering performance.

The following embodiments and aspects thereof are described and illustrated in conjunction with systems, tool and methods which are meant to be exemplary and illustrative, not limiting in scope. In various embodiments, one or more of the above described problems have been reduced or eliminated, while other embodiments are directed to other improvements.

The exhaust particulate filter according to the invention has a filter body with a number of filter pockets arranged one behind the other and formed from filter plates. The filter plates have a planar cutout opening with a peripheral contour bordering the cutout opening. The peripheral contour of the cutout opening comprises points which are located at different distances from the centroid of the area of the cutout opening.

A filter plate is understood here as meaning a plate-shaped blank of a porous material with a filtering effect of comparatively small thickness in the millimeter range. The corresponding material preferably has a filtering effect in the sense of a surface filter. The material can be made up of interwoven fibers and possibly be mechanically stabilized by reinforcing inserts. However, a flat metallic support with a multiplicity of small openings, such as a grid or a screen, is preferably used. The support may also be in the form of a mat made up of interwoven wire material or in the form of a grid-shaped expanded metal. Porous fiber mats may be applied to the support and form a multilayered composite structure with the support.

The openings are preferably filled with a granular material, the bonding of which is achieved by a sintering process. The outer form of the filter plate blank is adapted to the installation requirements of forming a filter body. There is great variability with regard to the freedom of design. The filter plates may, according to requirements, be of a round, oval, rectangular or polygonal form. Forms which have an axis of symmetry or point symmetry are preferred.

The cutout opening of the filter plate is formed as an area for which a peripheral contour bounding the area and a geometrical centroid are defined in the usual way. The peripheral contour comprises points which are located at different distances from the centroid, which results in a t cutout opening that deviates from a circular form, that is to say has a non-circular design or peripheral contour. By contrast with the known circular configuration of the cutout opening, the cutout opening can have forms that are conducive to flow and optimally adapted to the respective flow profile. This allows the disadvantageous dead zones in the flow to be avoided. Correspondingly configured filter pockets have largely uniformly flow through and particulate cover. This improves the filtering performance and the counter pressure characteristics.

In this case, the area of the cutout opening is also understood as meaning areas that are not contiguous. This is synonymous with the fact that a cutout opening of a filter plate may be formed by a number of sub-areas, or at least two sub-areas, that are separated from one another. The centroid of such a divided cutout opening area may consequently lie outside the openings. In this case, the individual sub-areas may have a circular design or be designed in a non-circular manner. The sub-areas are preferably distributed on the filter plate such that flow conditions are as uniform as possible form where the filter pocket accepts incoming flow and inside the filter pocket. This is achieved in particular by a cutout opening that is arranged off-center with respect to the filter plate, in the vicinity of an edge region of the filter plate, or by a number of cutout openings arranged off-center. It is likewise advantageous for the cutout opening to extend into an edge region of the filter plate.

An exhaust particulate filter according to the invention can also have the corresponding filter plates of the filter pockets having at least one planar cutout opening with the centroid of the area of the cutout opening being arranged at a distance from the central longitudinal axis of the filter body on the filter plate. Since the filter pockets are arranged one behind the other, a cylindrical filter body is obtained. Correspondingly, a central longitudinal axis is defined for the resultant filter body, and the centroid of the areas of the cutout openings of the filter plates is offset with respect to this axis.

It is advantageous if the filter plates have at least one axis of symmetry and the centroid of the area of the cutout opening is arranged on the far side of at least one axis of symmetry. Consequently, the cutout openings are arranged decentrally, or off-center, of the symmetrically formed filter plate. However, the filter plates bounding the filter pockets preferably have a point-symmetrical design and the centroid of the area of the cutout opening is therefore arranged on the far side of the point of symmetry on the filter plate.

In one embodiment of the invention, the cutout opening has a droplet-shaped peripheral contour. With this design, the inflow into the interior of the filter body can particularly be influenced.

In a further embodiment of the invention, the cutout opening is formed as a slot or in a triangular form. In this case, the slot may be of a rectangular, polygonal or oval form. In general, it is advantageous for the slot to have rounded off corners, as also in the case of a triangle, a polygon. In the case of a cutout opening formed by a number of sub-areas, they may have different geometries, allowing particularly effective influencing of the flow conditions. A filter pocket is preferably made up of filter plates with at least one sub-opening with a droplet-shaped, triangular or slot-shaped design. The filter plates may also have cutout openings with combined forms.

In a further embodiment, the filter plates have elevations directed toward the inner side of the filter pockets and/or toward the outer side of the filter pockets. These elevations are preferably formed as cusps or beads or webs. In particular, the elevations directed toward the inner side of the filter pocket serve to maintaining spacing. This prevents the filter plates of a filter pocket from being pressed flat against one another under the effect of the pressure of the exhaust gas, causing the exhaust flow to possibly be hindered or blocked. In particular in the case of elevations or spacers formed as beads, increased mechanical stability of the filter plates is also obtained by an increased flexural rigidity.

An exhaust particulate filter according to the invention is also formed by a filter body with the filter plates having different cutout openings. The cutout openings of different filter plates may deviate from one another with regard to the area content of the cutout opening area and/or their design. In this way, an adaptation to locally different incoming flow conditions is possible. In particular, it is possible to adapt the filter pockets to conditions that continually change in the main direction of exhaust flow. Consequently, allowance can be made for the exhaust mass flows or particulate depositions on the filter pocket walls that usually change in the main direction of exhaust flow.

It is particularly advantageous if, in a further embodiment of the invention, the filter body has filter plates with cutout openings with an increasing area content, seen in the main direction of exhaust flow. In this way, a particularly uniform outflow of exhaust gas from the individual filter pockets of the filter body is achieved.

In a further ebodiment of the invention, the filter body has filter plates with cutout openings with a design increasingly approaching a circular form in the main direction of exhaust flow. In this way, on the terminating side with respect to the filter body a transition to a pipeline receiving the cleaned exhaust gas flow is made possible in an advantageous way.

In a further embodment of the invention, the filter plates are formed in a substantially planar manner and the filter plates of a respective filter pocket are arranged at a small distance from one another in planes running parallel to one another. This simplifies the production of the filter pockets, since they can be produced from substantially planar blanks of the filter plate material, possibly also by simple bending.

In a further embodiment of the invention, the filter plates are formed as sintered metal filter plates. Such a sintered metal filter plate may be a plate blank of sintered metal fiber material. However, such a sintered metal filter plate is preferably formed by a planar metal grid blank of small thickness, the grid openings being filled by a metal-containing powder which has been subjected to a sintering process. Woven wire structures or expanded metal are preferably used as the grid-shaped support of the sintered metal filter plate. Any type of support and sintered material familiar to a person skilled in the art and of adequate durability for the corresponding application can be used. The porosity of the sintered metal filter plate can be specifically set for example by the grain size of the sintered material and the sintering process.

On account of the thermal stability of sintered metal material, correspondingly configured particulate filters are particularly suitable for cleaning exhaust gases of internal combustion engines in motor vehicles.

In addition to the exemplary aspects and embodiments described above, further aspects and embodiments will become apparent by reference to the accompanying drawings forming a part of this specification wherein like reference characters designate corresponding parts in the several views.

### BRIEF DESCRIPTION OF THE DRAWINGS

FIG. 1a is a prior art filter plate for forming a filter pocket for a filter body.

FIG. 1b is a schematic longitudinal sectional representation of a filter body made up of the filter plates of FIG. 1a.

FIG. 2a is a first preferred embodiment of a filter plate for forming an exhaust particulate filter.

FIG. 2b is a second preferred embodiment of a filter plate for forming an exhaust particulate filter.

FIG. 3 is a third preferred embodiment of a filter plate for forming an exhaust particulate filter.

FIG. 4 is a fourth preferred embodiment of a filter plate for forming an exhaust particulate filter.

FIGS. 5a to 5d are further preferred embodiments of a filter plate for forming an exhaust particulate filter.

FIG. 6 is a schematic representation of an arrangement of filter plates for forming an exhaust particulate filter.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION OF THE DRAWINGS

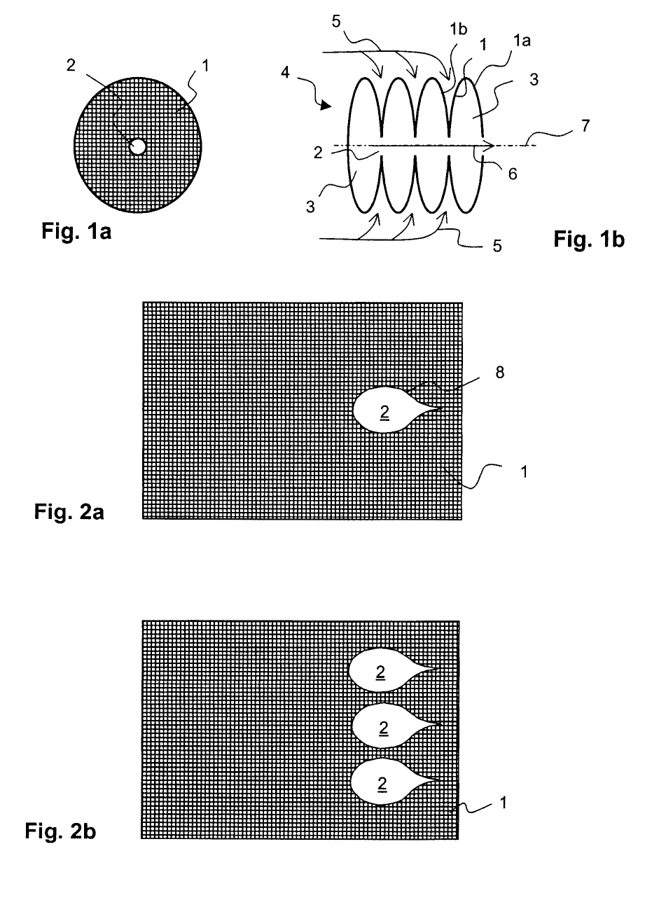

In FIG. 1a, a prior art sintered metal filter plate 1 is represented, as used in a known way for forming a filter body for an exhaust particulate filter. The sintered metal filter plate 1 has a circular configuration and has a centrally arranged circular cutout opening 2.

Referring next to FIG. 1B, to form a prior art filter body, a multiplicity of identical sintered metal filter plates 1 are mutually connected to one another, forming a stack-shaped arrangement. In this arrangement each sintered metal filter plate 1 has two nearest neighbors, other than the sintered metal filter plates 1 at the ends. The same procedure can be followed in principle in an analogous way for the construction of a filter body according to the invention.

The connection of the sintered metal filter plates 1 takes place such that a sintered metal filter plate 1 is connected all the way around its outer periphery to its first neighbor 1a, for example by welding. Furthermore, this sintered metal filter plate 1 is connected all the way around the peripheral contour of the cutout opening 2 to its second neighbor 1b, for example by welding. In this way, an arrangement of filter pockets arranged one behind the other and formed by filter plates 1 is obtained.

In FIG. 1b, a filter body 4 formed in this way is schematically represented in longitudinal section, only one sintered metal filter plate 1 being identified by the corresponding designation. It can be seen that the connection of the sintered metal filter plates 1 in pairs has the effect of forming individual filter pockets 3 arranged one behind the other, which altogether form the cylindrical filter body 4. With preferably used axis-symmetrical or point-symmetrical filter plates 1, said filter body has a central longitudinal axis 7. To form an exhaust particulate filter, the filter body 4 is fitted in a housing (not represented), so that integration in an exhaust system of an internal combustion engine (not represented) can take place.

As indicated by the arrows 5, an approximately radial inflow of exhaust gas with respect to the filter body 4 takes place into the interior of the filter body 4 or the filter pockets 3. A filtering of the exhaust gas takes place when the gas passes through the porous sintered metal filter plates 1. Particulates contained in the exhaust gas deposit themselves on the outside of the sintered metal filter plates with respect to the filter body 4. Filtered exhaust gas is carried away through the cutout openings 2 in a manner corresponding to the main direction of exhaust flow represented by the arrow 6.

A high packing density of filter pockets 3 is usually used to achieve a good filtering effect. This results in correspondingly small distance between the sintered metal filter plates 1. On the outside of the filter body 4, the distances between the sintered metal filter plates 1 of two neighboring filter pockets 3 narrow in the radially inward direction. On the inside of the filter body 4, the distances between the sintered metal filter plates 1 of each filter pocket 3 narrow in the radially outward direction. This produces critical conditions both in the radially inner region and in the radially outer region with respect to uniform incoming flow and flow through the filter pockets 3 and the entire filter body 4. According to the invention, the flow conditions are improved by specially designed filter plates 1. In particular, according to the invention, a special position, geometry and number of cutout openings 2 makes it possible to avoid dead zones in terms of flow and to improve the counter pressure behavior.

A number of particularly advantageous embodiments of filter plates 1 are described below on the basis of examples. Although the filter plates 1 may be produced from any desired material that is suitable for the application, it is assumed hereafter that the filter plates 1 are sintered metal filter plates of a customary kind and the connection of the individual filter plates 1 to form a filter body 4 takes place in the way described. Reference is therefore made to FIG. 1b for the features of the filter body obtained. The filter plates for forming a particulate filter according to the invention are preferably formed in a point-symmetrical or axis-symmetrical manner with a circular or oval form or as a polygon. However, a rectangular form is assumed hereafter for the filter plate, without restricting generality.

Referring next to FIG. 2a, a rectangular filter plate 1 has a cutout opening 2 with an area or peripheral contour 8 of a droplet-shaped form. The droplet form of the cutout opening 2 has the effect of reducing the flow resistance of the overall filter body 4, in particular on the raw gas side. At the same time, a more uniform incoming flow and a low pressure loss are achieved on both the raw gas side and on the clean gas side. Dead zones in terms of flow can be largely avoided by the form of the cutout opening 2. The transition from the cutout opening into the clean gas space in the filter pocket interior (plenum) is improved by the non-circular, droplet-shaped design of the cutout opening 2 in comparison with a circular cutout opening of the prior art, such that a reduced pressure loss is obtained as a result. In particular, it is advantageous to arrange the cutout opening off-center on the filter plate 1, as represented.

Greater improvement can be obtained by providing a number of cutout openings 2, as seen in FIG. 2b. In the depicted embodiment, the openings are arranged one below the other on one side of the filter plate 1 at a lateral distance from the center of the filter plate. It is to be understood that the outlet openings 2 may also be arranged on the filter plate 1 in some other way. The provision of a number of outlet openings 2, in particular droplet-shaped openings, has the effect of reducing the turbulence and the proportionate number of deflections at right angles to the main direction of exhaust flow 6, and consequently the pressure loss. It is to be understood that the outlet openings 2 deviating from the form of a droplet are likewise possible.

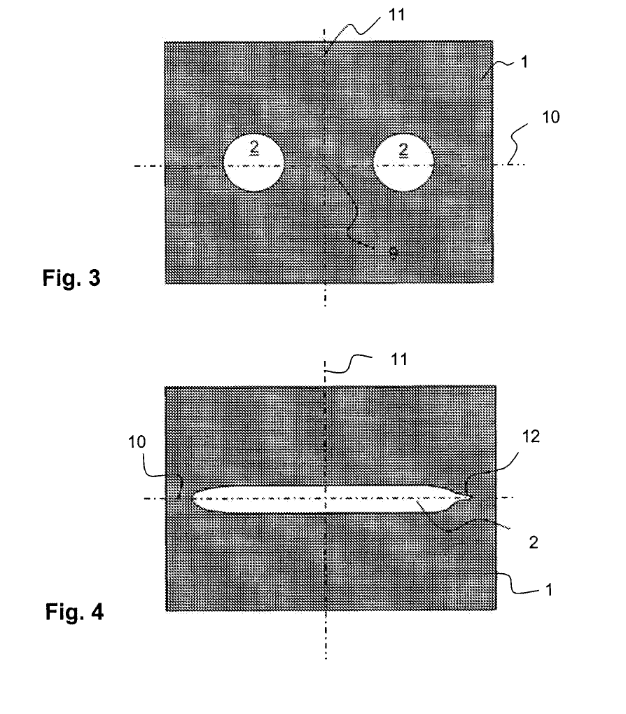

A further advantageous embodiment of a filter plate 1 for forming an exhaust particulate filter is represented in FIG. 3. Two circular cutout openings 2 are arranged symmetrically in relation to a first main axis 11 of the filter plate 1 on the filter plate 1 in such a way that the center points lie on the second main axis 10. This likewise makes possible a uniform inflow into the inner region of the corresponding filter pockets. As can be seen in FIG. 3, the centroids of the two parts of the cutout opening 2 are respectively arranged at a distance from the central longitudinal axis 7 of a corresponding filter body 4 on the filter plate 1. In this case, the center point 9 indicates the point of penetration of the central longitudinal axis 7 of the corresponding filter body 4.

Advantageous flow properties are also obtained if the cutout opening is formed as a slot, as shown in FIG. 4. In the depicted embodiment the cutout opening 2 configured as a slot has an end region 12 designed like a tip or continuation. The cutout opening 2 may have an end region 12 designed in such a way on one or on both sides. Filter plates with a slot-shaped cutout opening also make it possible to construct particularly low, flat filter bodies with outstanding flow properties and filtering performances. In the case of a rectangular filter plate 1, it is advantageous in particular for a uniform flow distribution if the slot-shaped cutout opening 2 extends parallel to the longer side of the filter plate rectangle and is arranged on the corresponding main axis 10 of the filter plate 1.

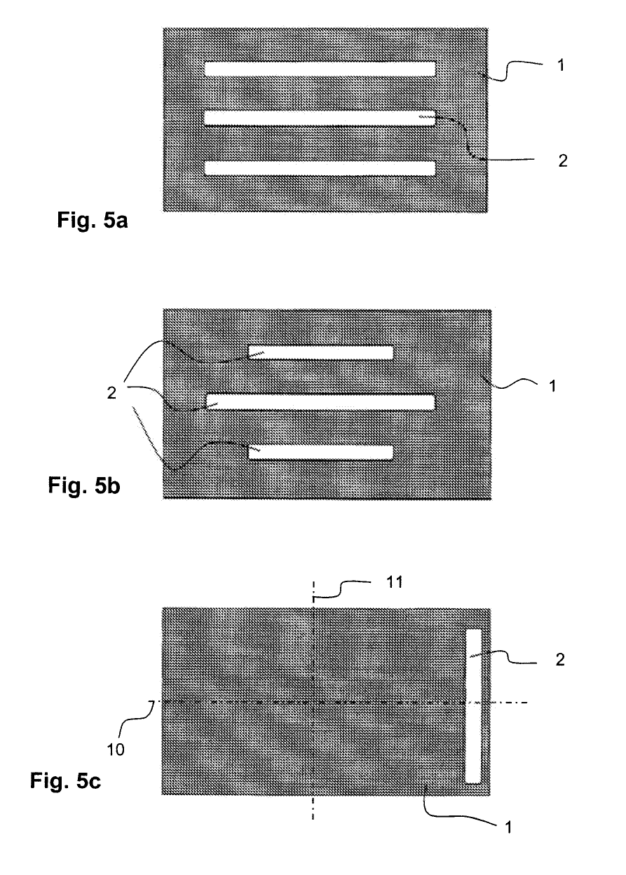

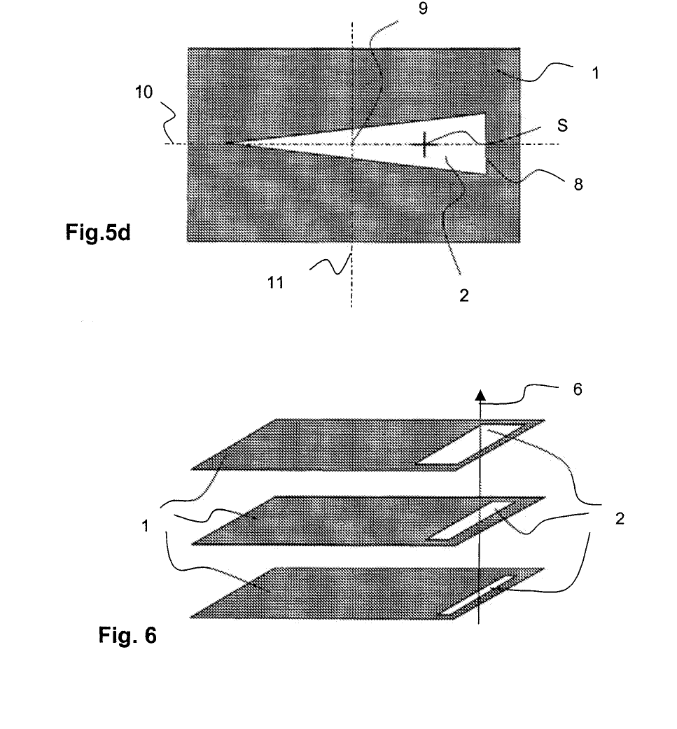

Further examples of preferred embodiments of a filter plate for forming an exhaust particulate filter are represented in FIGS. 5a to 5d. FIG. 5a shows a filter plate 1 with three slot-shaped cutout openings 2 of equal size similar to those represented in FIG. 4. By contrast, the filter plate 1 as shown in FIG. 5b has slot-shaped cutout openings 2 with different cutout opening areas. In the present case, this is the result of the different longitudinal extent of the cutout openings 2. It to be understood that it is possible to realize the different cutout opening areas by slots of the same length but different widths, or in some other way.

For example, it may also be advantageous to configure the cutout opening 2 as a slot and to arrange it at one edge of the filter plate 1 for reasons of structural design requirements, in a way similar to the arrangement represented in FIG. 2a. FIG. 5c shows such an embodiment by way of example. In the case of this embodiment, a cutout opening 2 in the form of a slot is provided for the filter plate 1. The cutout opening 2 is arranged at a distance from and with parallel alignment in relation to the first main axis 11 on the filter plate 1. Furthermore, the cutout opening 2 has an axis symmetry with respect to the second main axis 10 of the rectangular filter plate 1.

In FIG. 5d, a further preferred embodiment of a filter plate for forming an exhaust particulate filter according to the invention is represented. The filter plate 1 has a cutout opening 2 in the form of an acute-angled triangle with a corresponding peripheral contour 8. As shown, the centroid S of the area of the cutout opening is at a distance from the center point of symmetry 9 of the filter plate 1, the center point of symmetry 9 being defined by the point of intersection of the main axes 10, 11 of the filter plate 1. At the same time, the central longitudinal axis 7 of a filter body 4 according to FIG. 1b, constructed with corresponding filter pockets 3, runs through said center point. The form of the cutout opening may be adapted to the flow conditions within the particulate filter housing in which the filter body 4 is arranged. This is advantageous to create optimum flow conditions in particular in the case of lateral entry of the exhaust gas into the particulate filter housing or in the case of lateral exit of the exhaust gas from the particulate filter housing. To achieve a uniformly distributed pressure loss over the filter body 4 formed by a multiplicity of filter pockets 3 arranged one behind the other, with corresponding filter plates 1, it is advantageous if the cutout opening area increases in the main direction of exhaust flow 6.

Such an arrangement is schematically represented in FIG. 6. Only three filter plates 1 arranged one behind the other are represented. The mutual connection of the filter plates 1 to form filter pockets 3 has not been shown for reasons of overall clarity. As shown, the filter plates 1 here have slot-shaped cutout openings 2. The cutout opening area in this case increases in the direction of the main direction of exhaust flow, represented by the arrow 6. As a result, allowance is made for the fact that amounts of gas increasing in the indicated direction flow through the cutout openings 2. The pressure loss, tending to increase as a result, as the exhaust passes through a respective cutout opening 2 is avoided by the increasing cutout opening area. Although, in the embodiment represented in FIG. 6, the cutout opening 2 of the respective filter plate 1 is formed as a slot arranged off-center, it is to be understood that other forms and positions are also possible for the cutout opening 2. In particular, a design of the cutout opening 2 corresponding to one of the forms represented in FIGS. 2 to 5 is possible and advantageous.

In general, the individual filter plates 1 of a filter body 4 may have different cutout openings, both with regard to the design and with regard to the area content. For the connection of a pipe, it is advantageous if the form of the cutout opening approaches a circular form toward the end of the outflow side of the filter body 4. Finally, it is generally advantageous to provide the filter plates 1 with local elevations in the form of embossments directed into the inner side of the filter pockets (not represented in the figures). These may be formed as cusps or beads or webs, which rise up toward the inner side of a respective filter pocket 3. It is advantageous to provide approximately uniformly distributed cusp-shaped elevations for the filter plates 1. This avoids the filter plates 1 of a respective filter pocket 3 being able to be pressed flat against one another by the pressure of the exhaust gas, and the gas flow being blocked as a result. Moreover, the elevations give the filter plates 1 greater mechanical stability.

In the event that a number of cutout openings 2 are arranged on a respective filter plate 1, there may be regions on a filter plate 1 that do not have a filtering effect. These may then be made of a gastight material and additionally have a fastening element for fastening the filter body 4 to the surrounding housing. It is to be understood that at least the gas-permeable, porous regions of the filter plates 1 may be catalytically coated, in order to aid the burning off of deposited soot particulates.

While a number of exemplary aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations are within their true sprit and scope. Each apparatus embodiment described herein has numerous equivalents.

I claim:

1-10. (canceled)

11. An exhaust particulate filter, with a filter body comprising:
a number of filter pockets arranged one behind the other and formed by connecting filter plates in pairs;
the filter plates having a planar cutout opening with a peripheral contour bordering the cutout opening;
wherein the peripheral contour comprises points which are located at different distances from a centroid of the area of the cutout opening.

12. An exhaust particulate filter, with a filter body comprising:
a number of filter pockets arranged one behind the other and formed by connecting filter plates in pairs, the filter plates having at least one planar cutout opening;
wherein a centroid of the at least one area of the cutout opening is arranged at a distance from a central longitudinal axis of the filter body on the filter plate.

13. An exhaust particulate filter, with a filter body comprising:
a number of filter pockets arranged one behind the other and formed by connecting filter plates in pairs, the filter plates having at least one planar cutout opening;
wherein the filter body has filter plates with different cutout openings.

14. The exhaust particulate filter as claimed in claim 11, wherein the cutout opening has a droplet-shaped peripheral contour.

15. The exhaust particulate filter as claimed in claim 12, wherein the cutout opening has a droplet-shaped peripheral contour.

16. The exhaust particulate filter as claimed in claim 13, wherein at least one cutout opening has a droplet-shaped peripheral contour.

17. The exhaust particulate filter as claimed in claim 11, wherein the cutout opening is formed as a slot or in a triangular form.

18. The exhaust particulate filter as claimed in claim 12, wherein the cutout opening is formed as a slot or in a triangular form.

19. The exhaust particulate filter as claimed in claim 13, wherein at least one cutout opening is formed as a slot or in a triangular form.

20. The exhaust particulate filter as claimed in claim 11, wherein the filter plates have elevations directed toward the inner side of the filter pockets and/or toward the outer side of the filter pockets.

21. The exhaust particulate filter as claimed in claim 12, wherein the filter plates have elevations directed toward the inner side of the filter pockets and/or toward the outer side of the filter pockets.

22. The exhaust particulate filter as claimed in claim 13, wherein the filter plates have elevations directed toward the inner side of the filter pockets and/or toward the outer side of the filter pockets.

23. The exhaust particulate filter as claimed in claim 11, wherein the filter body has filter plates with cutout openings with an increasing area content, seen in a main direction of exhaust flow.

24. The exhaust particulate filter as claimed in claim 12, wherein the filter body has filter plates with cutout openings with an increasing area content, seen in a main direction of exhaust flow.

25. The exhaust particulate filter as claimed in claim 13, wherein the filter body has filter plates with cutout openings with an increasing area content, seen in a main direction of exhaust flow.

26. The exhaust particulate filter as claimed in claim 11, wherein the filter body has filter plates with cutout openings with a design increasingly approaching a circular form in a main direction of exhaust flow.

27. The exhaust particulate filter as claimed in claim 12, wherein the filter body has filter plates with cutout openings with a design increasingly approaching a circular form in a main direction of exhaust flow.

28. The exhaust particulate filter as claimed in claim 13, wherein the filter body has filter plates with cutout openings with a design increasingly approaching a circular form in a main direction of exhaust flow.

29. The exhaust particulate filter as claimed in claim 11, wherein the filter plates are formed in a substantially planar manner and the filter plates of a respective filter pocket are arranged at a small distance from one another in planes running parallel to one another.

30. The exhaust particulate filter as claimed in claim 12, wherein the filter plates are formed in a substantially planar manner and the filter plates of a respective filter pocket are arranged at a small distance from one another in planes running parallel to one another.

31. The exhaust particulate filter as claimed in claim 13, wherein the filter plates are formed in a substantially planar manner and the filter plates of a respective filter pocket are arranged at a small distance from one another in planes running parallel to one another.

32. The exhaust particulate filter as claimed in claim 11, wherein the filter plates are formed as sintered metal filter plates.

33. The exhaust particulate filter as claimed in claim 12, wherein in that the filter plates are formed as sintered metal filter plates.

34. The exhaust particulate filter as claimed in claim 13, wherein the filter plates are formed as sintered metal filter plates.
